(19) United States
(12) Patent Application Publication
(10) Pub. No.: US 2024/0220860 A1
(43) Pub. Date: Jul. 4, 2024

(54) MACHINE LEARNING MODEL AGGREGATION

(71) Applicant: Micron Technology, Inc., Boise, ID (US)

(72) Inventors: Pavana Prakash, Houston, TX (US); Shashank Bangalore Lakshman, Folsom, CA (US); Febin Sunny, Folsom, CA (US); Saideep Tiku, Fort Collins, CO (US); Poorna Kale, Folsom, CA (US)

(21) Appl. No.: 18/393,357

(22) Filed: Dec. 21, 2023

Related U.S. Application Data
(60) Provisional application No. 63/435,959, filed on Dec. 29, 2022.

(51) Int. Cl. G06N 20/00

(52) U.S. Cl. CPC G06N 20/00

(57) ABSTRACT

Methods and systems associated with a machine learning model aggregation are described. A system can include a first computing device, a second computing device, a local federated server, and a global federated server. The first computing device and the second computing device can train respective first and second machine learning models based on gathered memory usage data and device characteristic data associated with a respective first plurality of memory devices and second plurality of memory devices. The local federated server can aggregate the first machine learning model and the second machine learning model into a third machine learning model. The global federated server can aggregate the third machine learning model with a fourth machine learning model comprising a plurality of aggregated machine learning models into a fifth machine learning model and predict aging of the first plurality of memory devices and the second plurality of memory devices.

### PRIORITY INFORMATION

This application claims the benefit of U.S. Provisional Application No. 63/435,959, filed on Dec. 29, 2022, the contents of which are incorporated herein by reference.

### TECHNICAL FIELD

The present disclosure relates generally to systems and methods associated with machine learning model aggregation.

### BACKGROUND

Memory devices are typically provided as internal, semiconductor, integrated circuits in computers or other electronic systems. There are many different types of memory, including volatile and non-volatile memory. Volatile memory can require power to maintain its data (e.g., host data, error data, etc.). Volatile memory can include random access memory (RAM), dynamic random-access memory (DRAM), static random-access memory (SRAM), synchronous dynamic random-access memory (SDRAM), and thyristor random access memory (TRAM), among other types. Non-volatile memory can provide persistent data by retaining stored data when not powered. Non-volatile memory can include NAND flash memory, NOR flash memory, and resistance variable memory, such as phase change random access memory (PCRAM) and resistive random-access memory (RRAM), ferroelectric random-access memory (FeRAM), and magnetoresistive random access memory (MRAM), such as spin torque transfer random access memory (STT RAM), among other types.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system. A controller may be used to manage the transfer of data, commands, and/or instructions between the host and the memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2 is a flow chart illustrating an example of machine learning model aggregation in accordance with a number of embodiments of the present disclosure.

FIG. 3 is a functional block diagram representing an example of machine learning model aggregation in accordance with a number of embodiments of the present disclosure.

FIG. 4 is a flow diagram representing an example method for machine learning model aggregation in accordance with a number of embodiments of the present disclosure.

### DETAILED DESCRIPTION

Systems, devices, and methods related to machine learning model aggregation are described. Machine learning models can be used to determine a device's mean time to failure (MTTF), which is a predicted time from first operation until failure of a mechanical or electronic system during normal system operation. MTTF may also be referred to as mean time between failures (MTBF) (e.g., for reparable systems). As used herein, MTTF and MTBF may be used interchangeably. A greater MTTF predicts a longer working system before failure as compared to a lesser MTTF.

Device aging in memory can lead to performance degradation in devices, which can ultimately result in device failure. Device failure can result in system down time and reduced output due to needed repairs and/or replacements. Some approaches to predicting aging and/or MTTF can include in-lab evaluation of each device to predict aging, but this can be expensive and time-consuming.

In contrast, examples of the present disclosure can include the use of memory-side channel analysis to federate memory usage characteristics on devices without sharing private data of the device. Tiered federated-aging characterizations can be built, with machine learning models built at different tiers and aggregated to predict memory device MTTF with different specificities. For instance, machine learning models generated at lower tiers may offer more memory device specific aging predictions as compared to more generic, global machine learning models generated via aggregation of the lower-tier machine learning models. The different tiers of machine learning models can be deployed on customer platforms at different price points based on the respective models' specificity.

Examples of the present disclosure can include a first computing device, a second computing device, a local federated server in communication with the first computing device and the second computing device, and a global federated server in communication with the local federated server. The first computing device can gather memory usage data and device characteristic data associated with a first plurality of memory devices monitored by the first computing device and train a first machine learning model based on the gathered memory usage data and the device characteristic data associated with the first plurality of memory devices. The second computing device can gather memory usage data and device characteristic data associated with a second plurality of memory devices monitored by the second computing device and train a second machine learning model based on the gathered memory usage data and the device characteristic data associated with the second plurality of memory devices.

In some examples, the local federated server can aggregate the first machine learning model and the second machine learning model into a third machine learning model. The global federated server can aggregate the third machine learning model with a fourth machine learning model comprising a plurality of aggregated machine learning models into a fifth machine learning model and predict aging of the first plurality of memory devices and the second plurality of memory devices based on the fifth machine learning model.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context.

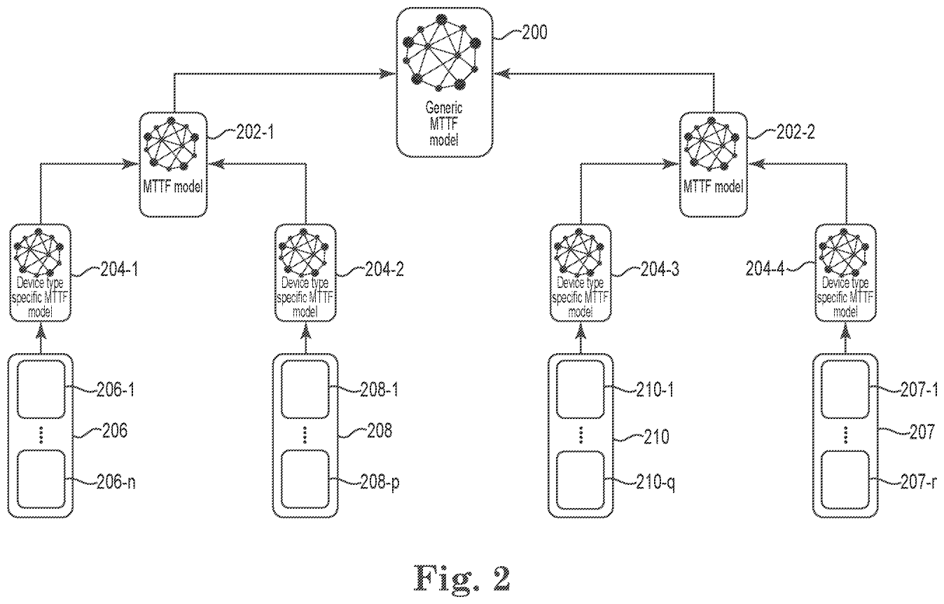

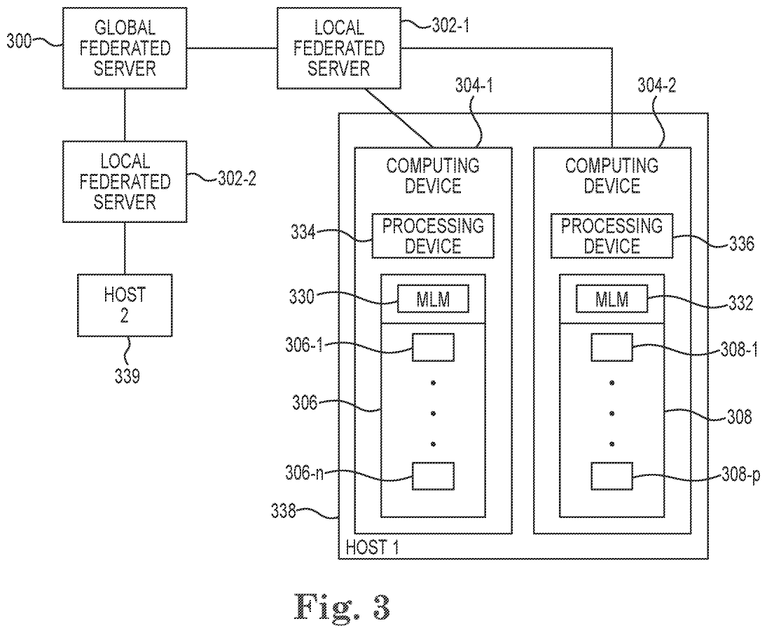

The figures herein follow a numbering convention in which the first digit or digits correspond to the figure number and the remaining digits identify an element or component in the figure. Similar elements or components between different figures can be identified by the use of similar digits. For example, 200 can reference element “00” in FIG. 2, and a similar element can be referenced as 300 in FIG. 3. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

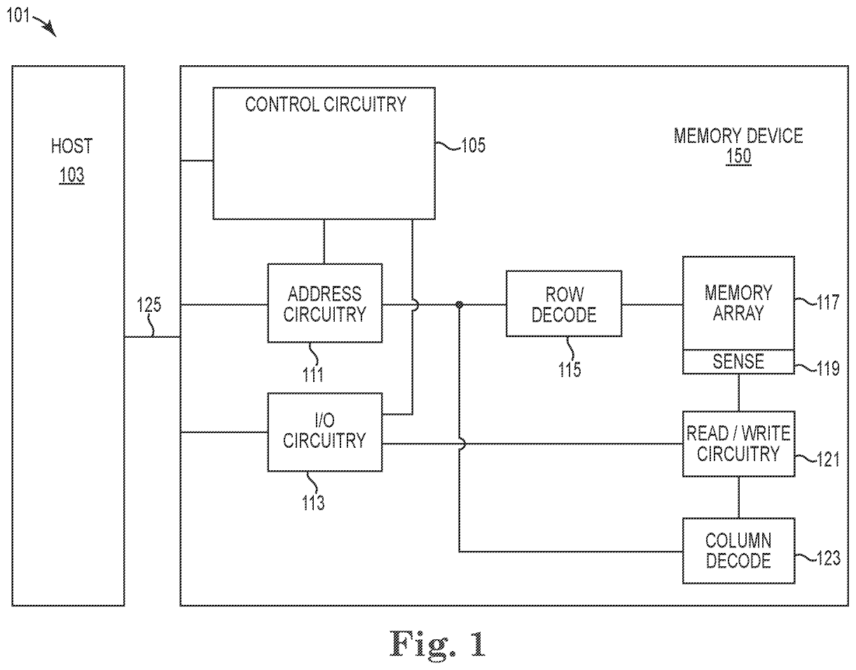

FIG. 1 is a block diagram of an apparatus in the form of a computing system 101 including a memory device 150 in accordance with a number of embodiments of the present disclosure. The memory device 150 is coupled to a host 103 via an interface 125. As used herein, a host 103, a memory device 150, or a memory array 117, for example, might also be separately considered to be an “apparatus.” The interface 125 can pass control, address, data, and other signals between the memory device 150 and the host 103. The interface 125 can include a command bus (e.g., coupled to the control circuitry 105), an address bus (e.g., coupled to the address circuitry 111), and a data bus (e.g., coupled to the input/output (I/O) circuitry 113). In some embodiments, the command bus and the address bus can be comprised of a common command/address bus. In some embodiments, the command bus, the address bus, and the data bus can be part of a common bus. The command bus can pass signals between the host 103 and the control circuitry 105 such as clock signals for timing, reset signals, chip selects, parity information, alerts, etc. The address bus can pass signals between the host 103 and the address circuitry 111 such as logical addresses of memory banks in the memory array 117 for memory operations. The interface 125 can be a physical interface employing a suitable protocol. Such a protocol may be custom or proprietary, or the interface 125 may employ a standardized protocol, such as Peripheral Component Interconnect Express (PCIe), Gen-Z interconnect, cache coherent interconnect for accelerators (CCIX), etc. In some cases, the control circuitry 105 is a register clock driver (RCD), such as RCD employed on an RDIMM or LRDIMM. In some embodiments, the interface 125 can be wireless.

The memory device 150 and host 103 can be a satellite, a communications tower, a personal laptop computer, a desktop computer, a digital camera, a mobile telephone, a memory card reader, an Internet-of-Things (IOT) enabled device, an automobile, among various other types of systems. For clarity, the system 101 has been simplified to focus on features with particular relevance to the present disclosure. The host 103 can include a number of processing devices (e.g., one or more processors, microprocessors, or some other type of controlling circuitry) capable of accessing the memory device 150.

The memory device 150 can provide main memory for the host 103 or can be used as additional memory or storage for the host 103. By way of example, the memory device 150 can be a dual in-line memory module (DIMM) including memory arrays 117 operated as double data rate (DDR) DRAM, such as DDR5, a graphics DDR DRAM, such as GDDR6, or another type of memory system. Embodiments are not limited to a particular type of memory device 150. Other examples of memory arrays 117 include RAM, ROM, SDRAM, LPDRAM, PCRAM, RRAM, flash memory, and three-dimensional cross-point, among others. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The control circuitry 105 can decode signals provided by the host 103. The control circuitry 105 can also be referred to as a command input and control circuit and can represent the functionality of different discrete ASICs or portions of different ASICs depending on the implementation. The signals can be commands provided by the host 103. These signals can include chip enable signals, write enable signals, and address latch signals, among others, that are used to control operations performed on the memory array 117. Such operations can include data read operations, data write operations, data erase operations, data move operations, etc. The control circuitry 106 can comprise a state machine, a sequencer, and/or some other type of control circuitry, which may be implemented in the form of hardware, firmware, or software, or any combination of the three.

Data can be provided to and/or from the memory array 117 via data lines coupling the memory array 117 to input/output (I/O) circuitry 113 via read/write circuitry 121. The I/O circuitry 113 can be used for bi-directional data communication with the host 103 over an interface. The read/write circuitry 121 is used to write data to the memory array 117 or read data from the memory array 117. As an example, the read/write circuitry 121 can comprise various drivers, latch circuitry, etc. In some embodiments, the data path can bypass the control circuitry 105.

The memory device 150 includes address circuitry 111 to latch address signals provided over an interface. Address signals are received and decoded by a row decoder 115 and a column decoder 123 to access the memory array 117. Data can be read from memory array 117 by sensing voltage and/or current changes on the sense lines using sensing circuitry 119. The sensing circuitry 112 can be coupled to the memory array 117. The sensing circuitry 119 can comprise, for example, sense amplifiers that can read and latch a page (e.g., row) of data from the memory array 117. Sensing (e.g., reading) a bit stored in a memory cell can involve sensing a relatively small voltage difference on a pair of sense lines, which may be referred to as digit lines or data lines.

The memory array 117 can comprise memory cells arranged in rows coupled by access lines (which may be referred to herein as word lines or select lines) and columns coupled by sense lines (which may be referred to herein as digit lines or data lines). Although the memory array 117 is shown as a single memory array, the memory array 117 can represent a plurality of memory arrays arraigned in banks of the memory device 150. The memory array 117 can include a number of memory cells, such as volatile memory cells (e.g., DRAM memory cells, among other types of volatile memory cells) and/or non-volatile memory cells (e.g., RRAM memory cells, among other types of non-volatile memory cells). In some examples, the memory device 150 may be part of a plurality of memory devices grouped together based on device characteristics.

The control circuitry 105 can also include additional circuitry not illustrated in FIG. 1. In some embodiments, the additional circuitry comprises an application specific integrated circuit (ASIC) configured to provide memory device 150 characteristics to a computing device in communication with the memory device 150 for MTTF determinations and aggregations. In some embodiments, the aggregation and MTTF determination circuitry comprises a deep learning accelerator (DLA) configured to perform the aggregation and MTTF determination examples described herein. The term “controller” may be used herein to refer to the functionality of the host 103, the control circuitry 105, and/or the additional circuitry.

The controller can be configured to provide usage data and device characteristics data of memory device 150 to a computing device in communication with the memory device 150, where a machine learning model (e.g., a local deep machine learning model, MMTF machine learning models, etc.) can be trained based on the memory usage data and device characteristic data. Device characteristic data can include operating characteristics such as voltage, current, temperature, etc. Memory usage data can include an amount of memory in use by the memory device 150 and/or how the memory is allocated.

The computing device can then send the local machine learning model to a local federated server, which can aggregate the local machine learning model with other local machine learning models to create local federated machine learning model. The local federated machine learning model can be aggregated with other local federated machine learning models at a global federated server to create a global machine learning model. The use of federated machine learning can allow for decentralization of training and can enable the aggregation of multiple machine learning models without having to share data. Rather, machine learning models created via aggregation are updated based on changes to lower machine learning models, not data changes.

FIG. 2 is a flow chart illustrating an example of machine learning model aggregation in accordance with a number of embodiments of the present disclosure. Memory devices with similar characteristics (e.g., memory type, part number, obligations, operations, operating conditions, etc.) can be identified and grouped together. Put another way, a first plurality of memory devices 206-1, . . . , 206-n can be a first categorized group 206 of memory devices having first device characteristics different than a second categorized group 208 of memory devices having second device characteristics of a second plurality of memory devices 208-1, . . . , 208-p.

For example, memory devices 206-1, . . . , 206-n in group 206 may have first characteristics, and memory devices 208-1, . . . , 208-p in group 208 may have second, different characteristics, while memory devices 207-1, . . . , 207-r in group 207 and memory devices 210-1, . . . , 210-q in group 210 may have third and fourth different characteristics, respectively. While four groups 206, 208, 210, 207 of memory devices each having respective similar characteristics are illustrated, more or fewer total groups of memory devices may be used, as well as different numbers of groups and group members. In some examples, devices other than memory devices may be present and their MTTF may be predicted.

Each memory device 206-1, . . . , 206-n, 208-1, . . . , 208-p, 210-1, . . . , 210-q, 207-1, . . . , 207-r can gather memory usage data and device characteristic data such as voltage, current, temperature, etc., and an associated computing device 204-1, 204-2, 204-3, 204-4 can train a respective local deep machine learning model based on the device characteristics data. For instance, the training may occur at a computing device 204-1, 204-2, 204-3, 204-4 (e.g., a local server) using manufacturing data. The computing devices 204-1, 204-2, 204-3, 204-4 can predict aging of their respective memory devices based on their respective local deep machine learning model. Put another way, the first computing device 204-1 predicts aging of the memory devices 206-1, . . . , 206-n based on its respective local machine learning model, and the second computing device 204-2 predicts aging of the memory devices 208-1, . . . , 208-p based on its respective local machine learning model. The computing devices 204-3 and 204-4 may follow a similar aging prediction approach.

The computing devices 204-1, 204-2, 204-3, 204-4 can send the local machine learning models to associated local federated servers 202-1, 202-2, which can aggregate the local machine learning models to create local federated machine learning models. Aggregation can include, for instance, the aggregation of weights and/or biases of machine learning models. Weights are learnable parameters of machine learning models and can determine how much influence input will have on output. Biases are normalizing parameters of machine learning models. Furthermore, the local federated servers 202-1, 202-2 can give greater or lesser significance (another type of “weight”) to local machine learning models determined at different computing devices 204-1, 204-2, 204-3, 204-4. For example, the local machine learning model from computing device 204-1 may have a higher significance (e.g., weight) than the local machine learning model determined at computing device 204-2, based on reliability of data, usage of the memory devices, etc. Aging predictions can be made at the local federated servers 202-1, 202-2, based on their respective local federated machine learning models. Aging predictions made at the computing devices 204-1, 204-2, 204-3, 204-4 using their respective local machine learning models are more specific than those made at the local federated servers 202-1, 202-2.

The local federated machine learning models trained at the local federated servers 202-1, 202-2 can be aggregated to create a global federated server 200, which can train a global machine learning model. The global machine learning model 200 can predict aging of memory devices 206-1, . . . , 206-n, 208-1, . . . , 208-p, 210-1, . . . , 210-q, 207-1, . . . , 207-r. The global machine learning model may be robust and generic since it is trained based on device characteristics of all the memory devices 206-1, . . . , 206-n, 208-1, . . . , 208-p, 210-1, . . . , 210-q, 207-1, . . . , 207-r. The global machine learning model and the local federated machine learning models are federated such that they are updated based on changes to machine learning models in a tier below them, but do not require specific customer data for updating. Aging predictions can be made at the global federated server 200, but local federated servers 202-1, 202-2 provide more specific aging predictions as compared to those made at the global federated server.

Because a machine learning model at each tier is an aggregate of the previous tier(s), a higher tier machine learning model is more generic as compared to a lower (e.g., previous) tier. In addition, the lower tier machine learning model may be more memory device specific as compared to a model in an upper tier. For instance, a machine learning model trained at computing device 204-1 is more memory device specific to the memory devices 206-1, . . . , 206-n than the machine learning model trained at the local federated server 202-1. Similarly, the machine learning model trained at the local federated server 202-1 is more device specific to the memory devices 206-1, . . . , 206-n than the machine learning model trained at the global federated server 200.

The tiered machine learning can be deployed onto other host devices, for instance, and may be monetized. For example, based on the tier level, the machine learning models may have higher or lower costs. The most generic, global machine learning model (e.g., a machine learning model trained at the global federated server 200) and associated data may be priced the least expensively. If more specific aging characterization is desired, a lower tier level machine learning model (e.g., machine learning models trained at the local federated servers 202-1, 202-2) and associated data may be utilized by a customer at a higher cost to the customer. Finally, if even more detailed and specific aging characterization is desired, the most expensively priced machine learning model and associated data may be the lowest tier memory device specific machine learning models (e.g., machine learning models trained at the computing devices 204-1, 204-2, 204-3, 204-4).

FIG. 3 is a functional block diagram representing an example of machine learning model aggregation in accordance with a number of embodiments of the present disclosure. The machine learning model aggregation may occur at a system including computing devices 304-1, 304-2, local federated servers 302-1, 302-2, a global federated server 300, or any combination thereof.

The computing device 304-1 can include a processing device 334 which may be in communication with the memory devices 306-1, . . . , 306-n of group 306, a different memory device, or both. The computing device 304-2 can include a processing device 336 which may be in communication with the memory devices 308-1, . . . , 308-p of group 308, a different memory device, or both. In some examples, the memory devices 306-1, . . . , 306-n and 308-1, . . . , 308-p or the different memory devices (e.g., a non-transitory machine readable medium (MRM)), may have stored instructions. In some examples, the instructions may be distributed (e.g., stored) across multiple memory devices and the instructions may be distributed (e.g., executed by) across multiple processing devices.

A memory device such as the memory devices 306-1, . . . , 306-n and 308-1, . . . , 308-p may be electronic, magnetic, optical, or other physical storage device that stores executable instructions. Thus, the memory device may be, for example, non-volatile or volatile memory. In some examples, a memory device is a non-transitory MRM comprising RAM, an Electrically-Erasable Programmable Read Only Memory (ROM) (EEPROM), a storage drive, an optical disc, and the like. A memory device may be disposed within a controller and/or computing device. In such an example, executable instructions can be “installed” on the memory device. Additionally, and/or alternatively, a memory device can be a portable, external or remote storage medium, for example, that allows a system to download the instructions from a portable/external/remote storage medium. In this situation, executable instructions may be part of an “installation package”.

A first host 338 can comprise a plurality of computing devices 304-1, 304-2, with the first computing device 304-1 having a first processing device 334 thereon, and the second computing device 304-2 having a second processing device 336 thereon. The first computing device 304-1 can have a group 306 of devices 306-1, . . . , 306-n (e.g., memory devices) thereon, and the second computing device 304-2 can have a group 308 of devices 308-1, . . . , 308-p (e.g., memory devices) thereon. While two computing devices, two processing devices, and two groups of devices are provided herein, a host may include more or less computing devices, each having more or less processing devices and groups of devices than illustrated in FIG. 3.

The first computing device 304-1 can develop and train a machine learning model (“MLM”) 330 based on usage data (e.g., memory usage data) and device characteristic data associated with the devices 306-1, . . . , 306-n. For instance, usage data and operational characteristics such as voltage, current, temperature, failure rate/time, etc. of the memory devices 306-1, . . . , 306-n can be gathered over time, and the gathered data can be used to create the device-specific machine learning model 330. The second computing device 304-2 can develop and train a machine learning model (“MLM”) 332 based on usage data (e.g., memory usage data) and device characteristic data associated with the devices 308-1, . . . , 308-p. Usage data and operational characteristics of the memory devices 308-1, . . . , 308-p can be gathered over time, and the gathered data can be used to create the device-specific machine learning model 332. In some examples, a first device type (e.g., devices within device group 306) and a second device type (e.g., devices within device group 308) associated with the same first host 338 may have different device-specific machine learning models 334 and 336. While memory devices are used as examples herein, other device types may be present and machine learning models specific to those device types may be created.

Using the gathered data, the device-specific machine learning models 330, 332 can be built and trained (e.g., using deep machine learning model training) at the respective computing devices 304-1, 304-2 to determine when a particular device is likely to fail, such that a problem can be intercepted and the device or component can be replaced before failure, which can reduce downtime of a server, host, etc., for example.

The device specific machine learning model 330 can be deployed onto the group 306 of devices on the first host device 338 and/or on devices (e.g., having comparable usage data and device characteristic data to those in group 306) at a different, second host 339. Similarly, in some instances, the device specific machine learning model 332 can be deployed onto the group 308 of devices on the first host device 338 and/or on devices (e.g., having comparable usage data and device characteristic data to those in group 308) at a different, second host 339.

For example, once the trained device specific machine learning model 330 is functional, the device specific machine learning model 330 can be shifted to a customer platform having that device type (e.g., a device having comparable usage data and device characteristic data to those in group 306). Similarly, once the trained device specific machine learning model 332 is functional, the device specific machine learning model 332 can be shifted to a customer platform having that device type (e.g., a device having comparable usage data and device characteristic data to those in group 308). The data being generated at the customer's platform can be used to update the device specific models 330, 332, such that the device specific models 330, 332 can improve and provide MMTF data and predictions associated with the respective device types in particular operation conditions.

In some examples, a respective MTTF can be collected for each of the plurality of devices 306-1, . . . , 306-n in group 306 and for each of the plurality of devices 308-1, . . . , 308-p in group 308 from the first host device 338 determined by the device specific machine learning models 330, 332, as well as from devices at the second host device 339 determined by the device specific machine learning models 330, 332 or machine learning models at the second host 339.

The MTTF data from the first host 338 can be aggregated at local federated server 302-1 into a first generic MTTF machine learning model based on the collected MTTFs. The generic MTTF machine learning model can be a federated machine learning model, allowing for training across a plurality of decentralized devices. For instance, weights of the different device specific models can be gathered, and the device specific models (e.g., their respective weights) can be aggregated to form a higher tier, and more generic, MTTF machine learning model. The generic MTTF machine learning model can predict a respective MTTF for more than one different device type (e.g., based on usage data and device characteristic data), but to a lesser extent, and with lesser accuracy, as compared to the device specific machine learning models 330, 332.

Weights derived from the first generic MTTF machine learning model can be aggregated with weights derived from a second generic MTTF machine learning model determined at the local federated server 302-2 into a global MTTF machine learning model at the global federated server 300. The generic MTTF machine learning models can be aggregated to make an even more generic, global MTTF machine learning model. The global MTTF machine learning model can predict an MTTF for more different device types (e.g., based on usage data and device characteristic data), but to a lesser extent, and with lesser accuracy, as compared to the generic MTTF machine learning models determined at the local federated servers 302-1, 302-2 and an even lesser extent than the device specific machine learning models 330, 332.

A respective MTTF can be determined for each of the plurality of different devices 306-1, . . . , 306-n and 308-1, . . . , 308-p, as well as other devices exposed to the different levels of machine learning models. For instance, an MTTF can be determined based on the device specific machine learning models 330, 332, the first generic MTTF machine learning model determined at the local federated server 302-1, the second generic MTTF machine learning model determined at the local federated server 302-2, the global MTTF machine learning model determined at the global federated server 300, or any combination thereof. For example, based on the level of specificity desired, a customer may choose to pay higher rates for a device specific machine learning model or lower rates for a generic or global machine learning model. Customers who did not collect the data for machine learning models may still have the machine learning models deployed on their devices as a service to determine an MTTF, allowing for potential interception of problems before occurrence. For example, it may be determined that a particular device has reached or is approaching a predicted MTTF, and based on the determination, an alert can be provided to the first host device 338, the second host device 339, or both depending on a location of the particular device and/or similar devices. This can allow for replacement/repair ahead of potential failure.

The device specific machine learning models 330, 332, as well as the generic machine learning models the global machine learning model and the can be updated in some examples. For instance, the first generic MTTF machine learning model can be updated in response to a change in one or more of the device specific machine learning models 330, 332. The global MTTF machine learning model can be updated in response to a change in one of the first generic MTTF machine learning model, the second generic MTTF machine learning model, or both. As new data is gathered (e.g., error rate, number of computing devices, number of machine learning models used, operations, heat, operational tabulations, operation characteristics, etc.), the different machine learning models can be updated. Customer data may not need to be shared with the upper tier machine learning models, as the upper tier models are aggregations of the lower tier machine learning models, and thus may not use customer-specific information when updating the machine learning models (e.g., via federated learning). In other words, in order to update higher tier models, the lower tier models need only pass model-specific data, such as updated weights and biases, rather than any user data.

In an example in which the devices of groups 306 and 308 are memory devices, memory usage data and device characteristic data can be gathered associated with the first group 306 of memory devices monitored by a first processing device 334, and a first machine learning model 330 can be trained based on the gathered memory usage data and the device characteristic data associated with the first group 306 memory devices. The first machine learning model 330 can be specific to a particular memory device type, for example, and can provide an MTTF for the particular memory device type in the current conditions.

Memory usage data and device characteristic data associated with a second group 308 of memory devices monitored by a second processing device 336 can be gathered, and a second machine learning model 332 can be trained based on the gathered memory usage data and the device characteristic data associated with the second group 308 memory devices. The second machine learning model can be specific to a particular memory device type different than that associated with the first machine learning model, for example and can provide an MTTF for the different particular memory device type in the current conditions.

The first machine learning model 330 and the second machine learning model 332 can be aggregated into a third machine learning model at the local federated server 302-1. For instance, weights associated with the first machine learning model 330 and the second machine learning model 332 can be aggregated to create the more generic federated third machine learning model. The first machine learning model 330 and the second machine learning model 332 may be chosen for aggregation based on similarities between their respective memory device types, operating conditions, usages, etc. More than two machine learning models may be aggregated in some examples.

The third machine learning model can be aggregated with a fourth machine learning model comprising a plurality of aggregated machine learning models (e.g., aggregated at computing devices of the second host 339 and/or at the local federated server 302-2) into a fifth machine learning model at the global federated server 300. Put another way, weights associated with the third machine learning model and the fourth machine learning model can be aggregated to create an even more generic, global fifth machine learning model. The fourth machine learning model, similar to the third machine learning model, can be a federated machine learning model created by aggregating memory device specific machine learning models (e.g., at the first host 339) into the more generic fourth machine learning model (e.g., at the local federated server 302-2).

Aging of the first group 306 of memory devices 306-1, . . . , 306-n and the second group 308 of memory devices 308-1, . . . , 308-p can be determined (e.g., predicted) based on the fifth machine learning model. Using the fifth machine learning model, an MTTF or other associated predictions for memory devices associated with the first machine learning model 330, the second machine learning model 332, and/or machine learning models contributing to the fourth machine learning model can be determined.

In some examples, aging of one or more of the memory devices 306-1, . . . , 306-n can be predicted based on the first machine learning model 330 and aging of one or more of the memory devices 308-1, . . . , 308-p can be predicted based on the second machine learning model 332. In other examples, aging of one or more of the memory devices 306-1, . . . , 306-n and one or more of the memory devices 308-1, . . . , 308-p can be predicted based on the third machine learning model. In such examples, the first machine learning model 330 provides a more specific aging prediction of the memory devices 306-1, . . . , 306-n and the second machine learning model 332 provides a more specific aging prediction of the memory devices 308-1, . . . , 308-p as compared to the third machine learning model. Similarly, the first machine learning model 330 provides a more specific aging prediction of the memory devices 306-1, . . . , 306-n and the second machine learning model 332 provides a more specific aging prediction of the memory devices 308-1, . . . , 308-p as compared to the fifth machine learning model. Also, the third machine learning model provides a more specific aging prediction of the memory devices 306-1, . . . , 306-n and the memory devices 308-1, . . . , 308-p as compared to the fifth machine learning model.

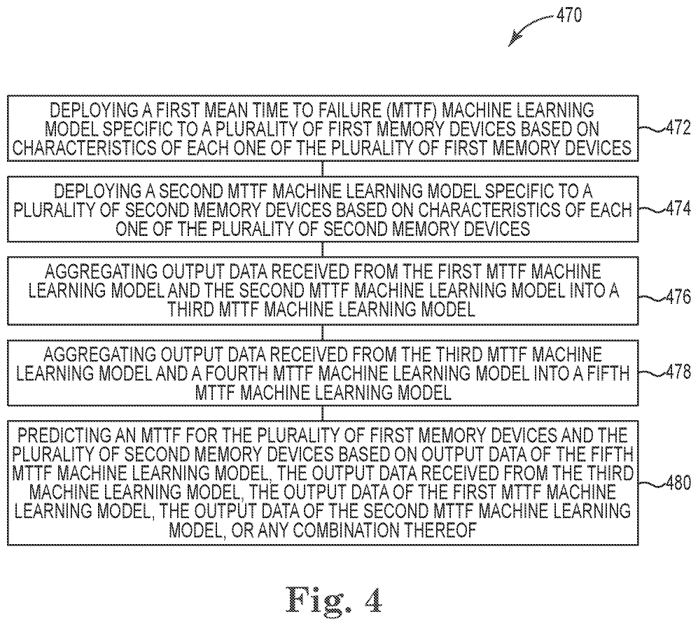

FIG. 4 is a flow diagram representing an example method 470 for machine learning model aggregation in accordance with a number of embodiments of the present disclosure. The method 470 may be performed, in some examples, using a device or system such as those described with respect to FIGS. 2 and 3. The method 470 can include machine learning model aggregation and MTTF predictions of different specificities based on a tiered machine learning model architecture.

The method 470, at 472, can include deploying a first mean time to failure (MTTF) machine learning model specific to a plurality of first memory devices based on characteristics of each one of the plurality of first memory devices, and at 474, the method 470 can include deploying a second MTTF machine learning model specific to a plurality of second memory devices based on characteristics of each one of the plurality of second memory devices. The first MTTF machine learning model may be trained based on memory usage data and device characteristic data of the plurality of first memory devices and the second MTTF machine learning model may be trained memory usage data and device characteristic data of the plurality of second memory devices based on characteristics of the plurality of second memory devices.

The deployment can include, for instance deploying the first MTTF machine learning model and the second MTTF machine learning model onto a host device hosting the plurality of first memory devices and the plurality of second memory devices. For instance, once the first and the second MTTF machine learning models are functional, they can be deployed to a customer's platform, and data can continue to be gathered. In some examples, the first MTTF machine learning model and the second MTTF machine learning model may be deployed on different host devices. For instance, the first MTTF machine learning model, the second MTTF machine learning model, or both, may be deployed on memory devices of a different host device. Put another way, the machine learning models may be trained at one device (e.g., a first server), and deployed on a second device (e.g., a customer platform).

At 476, the method 470 can include aggregating output data received from the first MTTF machine learning model and the second MTTF machine learning model into a third MTTF machine learning model. The output data, for instance, can include weights of the first MTTF machine learning model and the second MTTF machine learning model. While two machine learning models are described herein as aggregated to create the third MTTF machine learning model, more machine learning models may be created, deployed, and aggregated. In some examples, the first MTTF machine learning model and the second MTTF machine learning model are trained at respective computing devices in communication with the first plurality of memory devices and the second plurality of memory devices.

The third MTTF machine learning model can be updated, for instance at a local federated server, in response to a change in the first MTTF machine learning model, the second MTTF machine learning model, or both. For example, as weights of the first MTTF machine learning model and/or the second MTTF machine learning model change, the third MTTF machine learning model may be updated. These weights, for instance, may be affected by temperature changes, operational changes (e.g., using one memory device type more than others), age of memory devices, etc. While the first MTTF machine learning model and the second MTTF machine learning model are updated based on changes at the customer's devices, the third MTTF machine learning model is updated responsive to changes in the first and/or second machine learning models, such that customer data can remain private.

At 478, the method 470 can include aggregating output data (e.g., weights) received from the third MTTF machine learning model and a fourth MTTF machine learning model into a fifth MTTF machine learning model. The fourth MTTF machine learning model may be trained at a local federated server, and the fifth MTTF machine learning model may be trained at a global federated server, in some examples.

The fourth MTTF machine learning model can be a model created by aggregating other MTTF machine learning models (e.g., associated with different memory device types). For instance, the method 470 can include aggregating output data from a sixth MTTF machine learning model and a seventh MTTF machine learning model into the fourth MTTF machine learning model. The sixth MTTF machine learning model can be specific to a plurality of third memory devices on the host device or a different device, and the seventh MTTF machine learning model can be specific to a plurality of fourth memory devices on the host device or the different device.

In some examples, the third MTTF machine learning model and the fourth MTTF machine learning model may be deployed on different host devices. For instance, the third MTTF machine learning model, the fourth MTTF machine learning model, or both, may be deployed on memory devices of a different host device.

At 480, the method 470 can include predicting a respective MTTF for the plurality of first memory devices and the plurality of second memory devices based on output data of the fifth MTTF machine learning model, the output data received from the third machine learning model, the output data of the first MTTF machine learning model, the output data of the second MTTF machine learning model, or any combination thereof. For instance, depending on a specificity desired, a customer may choose to utilize the fifth MTTF machine learning model for a lower price and lower specificity. A different customer may choose the third machine learning model for a mid-price, and mid-specificity. Yet another customer may be interested in the MTTF of a specific memory device type, and may choose a more expensive, but more specific, first or second MTTF machine learning model.

The predicted MTTF can be provided to the host device (e.g., a host device hosting training of the plurality of first memory devices, the plurality of second memory devices, or both). In some instances, the fifth MTTF machine learning model can be deployed on memory devices of a different host device such that the training can occur at one host, but it may be deployed at another. The fifth MTTF machine learning model can be updated in response to a change in the third MTTF machine learning model, the fourth MTTF machine learning model, or both, and in some examples, an updated predicted MTTF can be provided to the host device each time one of the first, the second, the third, the fourth, or the fifth MTTF machine learning models is updated.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system, comprising:
a first computing device configured to:
gather memory usage data and device characteristic data associated with a first plurality of memory devices monitored by the first computing device; and
train a first machine learning model based on the gathered memory usage data and the device characteristic data associated with the first plurality of memory devices;
a second computing device configured to:
gather memory usage data and device characteristic data associated with a second plurality of memory devices monitored by the second computing device; and
train a second machine learning model based on the gathered memory usage data and the device characteristic data associated with the second plurality of memory devices; and
a local federated server in communication with the first computing device and the second computing device and configured to:
aggregate the first machine learning model and the second machine learning model into a third machine learning model;
a global federated server in communication with the local federated server and configured to:
aggregate the third machine learning model with a fourth machine learning model comprising a plurality of aggregated machine learning models into a fifth machine learning model; and
predict aging of the first plurality of memory devices and the second plurality of memory devices based on the fifth machine learning model.

2. The system of claim 1, wherein the first plurality of memory devices comprises a first categorized group of memory devices having first device characteristics different than a second categorized group of memory devices having second device characteristics of the second plurality of memory devices.

3. The system of claim 1, wherein the first computing device is configured to predict aging of the first plurality of memory devices based on the first machine learning model, and the second computing device is configured to predict aging of the second plurality of memory devices based on the second machine learning model.

4. The system of claim 1, wherein the local federated server is configured to predict aging of the first plurality of memory devices and the second plurality of memory devices based on the third machine learning model.

5. The system of claim 1, wherein the first machine learning model provides a more specific aging prediction of the first plurality of memory devices as compared to the third machine learning model; and
wherein the second machine learning model provides a more specific aging prediction of the second plurality of memory devices as compared to the third machine learning model.

6. The system of claim 1, wherein the first machine learning model provides a more specific aging prediction of the first plurality of memory devices; and
wherein the second machine learning model provides a more specific aging prediction of the second plurality of memory devices as compared to the fifth machine learning model.

7. The system of claim 1, wherein the third machine learning model provides a more specific aging prediction of the first plurality of memory devices and the second plurality of memory devices as compared to the fifth machine learning model.

8. A system, comprising:
a first plurality of memory devices grouped together based on memory device characteristics of the first plurality of memory devices;
a second plurality of memory devices, grouped together based on memory device characteristics of the second plurality of memory devices;
a first computing device configured to:
gather memory usage data and the memory device characteristics from the first plurality of memory devices;
train a first local machine learning model based on the gathered memory usage data and the memory device characteristics for the first plurality of memory devices;
determine a first mean time to failure (MTTF) for each one of the first plurality of memory devices based on the first local machine learning model;
a second computing device configured to:
gather memory usage data and the memory device characteristics from the second plurality of memory devices;
train a second local machine learning model based on the gathered memory usage data and the memory device characteristics for the second plurality of memory devices;
determine a second MTTF for each one of the second plurality of memory devices based on the second local machine learning model;
a local federated server configured to:
aggregate the first and the second local machine learning models into a first MTTF machine learning model; and
a global federated server configured to:
aggregate weights derived from the first generic machine learning model with weights derived from a second generic machine learning model into a global MTTF machine learning model; and
determine a respective MTTF for each of the first plurality of memory devices and the second plurality of memory devices based on the first local machine learning model, the second local machine learning model, the first generic machine learning model, the second generic machine learning model, the global MTTF machine learning model, or any combination thereof.

9. The system of claim 8, wherein the global federated server, the local federated server, the first computing device, or a combination thereof is configured to:
determine one of the first plurality of memory devices has reached an MTTF; and
based on determination, provide an alert to a host device of the plurality of first memory devices.

10. The system of claim 8, wherein the local federated server is configured to update the first generic machine learning model in response to a change in the first local machine learning model, the second machine learning model, or both.

11. The medium of claim 8, global federated server is configured to update the global machine learning model in response to a change in the first local machine learning model, the second local machine learning model, the first generic machine learning model, the second generic machine learning model, or any combination thereof.

12. A method, comprising:
deploying a first mean time to failure (MTTF) machine learning model specific to a plurality of first memory devices based on characteristics of each one of the plurality of first memory devices;
deploying a second MTTF machine learning model specific to a plurality of second memory devices based on characteristics of each one of the plurality of second memory devices;
aggregating output data received from the first MTTF machine learning model and the second MTTF machine learning model into a third MTTF machine learning model;
aggregating output data received from the third MTTF machine learning model and a fourth MTTF machine learning model into a fifth MTTF machine learning model; and
predicting a respective MTTF for each of the plurality of first memory devices and the plurality of second memory devices based on output data of the fifth MTTF machine learning model, the output data received from the third machine learning model, the output data of the first MTTF machine learning model, the output data of the second MTTF machine learning model, or any combination thereof.

13. The method of claim 12, further comprising providing the predicted MTTF to a host device hosting training of the plurality of first memory devices, the plurality of second memory devices, or both.

14. The method of claim 13, further comprising providing an updated predicted MTTF to the host device each time one of the first, the second, the third, the fourth, or the fifth MMTF machine learning models is updated.

15. The method of claim 12, further comprising aggregating output data from a sixth MTTF machine learning model and a seventh MTTF machine learning model into the fourth MTTF machine learning model,
wherein the sixth MTTF machine learning model is specific to a plurality of third memory devices, and the seventh MTTF machine learning model is specific to a plurality of fourth memory devices.

16. The method of claim 12, further comprising deploying the first MTTF machine learning model, the second MTTF machine learning model, or both, on memory devices of a second host device different than a first host device hosting training of the plurality of first memory devices, the plurality of second memory devices, or both.

17. The method of claim 12, further comprising deploying the third MTTF machine learning model, the fourth MTTF machine learning model, or both on memory devices of a second host device different than a first host device hosting training of the plurality of first memory devices, the plurality of second memory devices, or both.

18. The method of claim 12, further comprising deploying the fifth MTTF machine learning model on memory devices of a second host device different than a first host device hosting training of the plurality of first memory devices, the plurality of second memory devices, or both.

19. The method of claim 12, further comprising updating the fifth MTTF machine learning model in response to a change in the third MTTF machine learning model, the fourth MTTF machine learning model, or both.

20. The method of claim 12, further comprising updating the third MTTF machine learning model in response to a change in the first MTTF machine learning model, the second MTTF machine learning model, or both.
